(19) United States
(12) Patent Application Publication
(10) Pub. No.: US 2010/0094438 A1
(43) Pub. Date: Apr. 15, 2010

(54) METHOD FOR EXCHANGING STRUCTURAL COMPONENTS FOR AN AUTOMATION SYSTEM

(76) Inventor: Andreas Drebinger, Herzogenaurach (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/526,846

(22) PCT Filed: Feb. 14, 2008
(86) PCT No.: PCT/EP08/51800

§ 371 Date: Dec. 22, 2009

(30) Foreign Application Priority Data
Feb. 14, 2007 (DE) 10 2007 007 350.1

(51) Int. Cl. G05B 19/05

(52) U.S. Cl. 700/87

(57) ABSTRACT

According to the invention, during continuous operation of an automation system, one type of structural component is initially modified by a projection tool in the surroundings of the projection, independently of the start of operation of the structural component and a characteristic of the type is maintained in a constant manner. The instance the structural component is replaced in the function plan by the modified structural component and the structural modifications are correspondingly recorded. The exchanged structural component is transmitted into the automation system, parallel to the continuous operation of the automation system and without repercussions thereon. The uninterrupted switching to the configuration takes into account the exchanged structural component such that the modified and exchanged structural component is activated in the automation system.

### CROSS REFERENCE TO RELATED APPLICATIONS

This application is the US National Stage of International Application No. PCT/EP2008/051800, filed Feb. 14, 2008 and claims the benefit thereof. The International Application claims the benefits of German application No. 10 2007 007 350.1 filed Feb. 14, 2007, both of the applications are incorporated by reference herein in their entirety.

### FIELD OF THE INVENTION

The invention relates to a method for exchanging structural components for an automation system.

### BACKGROUND OF THE INVENTION

The automation of large plants such as for example power plants requires flexible and multipurpose control and automation systems in order to handle the control and regulation tasks that are becoming ever more complex.

Modifications or adaptations to current conditions are effected in the control system by means of configuration. In this process, predominantly graphic configuration tools are used nowadays. The modifications carried out in the control system in the configuration environment are put into effect in the runtime environment of the hierarchically subordinate automation system, which consists of a plurality of programmable logic controllers.

European standard EN 61131-3, also known as IEC 61131-3 or IEC 1131-3, defines five programming languages with which programmable logic controllers can be programmed. An example of a fully graphic configuration tool is the graphic programming language Continuous Function Chart (CFC), which can be used especially in programmable logic controllers in automation engineering. One component of the above-mentioned standard additionally uses the function block language Function Block Diagram (FBS). This is likewise a graphics-oriented programming language. In the FBS program, functions are represented by function blocks with inputs and outputs and their connections are represented by lines. In addition, variables and constants are also contained. Such an FBS program is often also referred to as a function plan.

Different types of function blocks exist within a function plan. Below, so-called structural components will be examined in particular, which are distinguished in that they are freely configurable and can be used user-specifically. Accordingly, a block type within the meaning of EN 61131-3 is referred to as a structural component, and can be freely configured by a user by parameterization and interconnection of basic types (i.e. standard blocks). Accordingly, a structural component type can be configured many times in the same way as a standard block type.

Up to now, a modification of such a structural component was always associated with considerable effort during configuration. In the same way as other program blocks, structural components always had to be modified manually at all points within the function plan. In particular, no facilities exist for flexibly modifying and updating existing structural components during continuous operation that have already been configured and activated in the automation system. Modifications of any kind in the configuration have always been associated with considerable limitations to continuous operation. As a rule, the process being executed had to be interrupted.

### SUMMARY OF THE INVENTION

The object underlying the invention is thus to provide a method for exchanging structural components for an automation system, in which the continuous operation of the automation system is not interrupted by introducing configured modifications.

This object is achieved in accordance with the features of the independent claim. Advantageous embodiments are in each case reflected in the dependent claims.

According to the invention, during the continuous operation of the automation system, one type of structural component is initially modified by means of a configuration tool in the configuration environment, independently of the execution of the function of the structural component, an identifier of the type always being maintained. Subsequently, the instance of the structural component is replaced in the function plan by the modified structural component and the structural modifications are correspondingly recorded. In a next step, the exchanged structural component is transferred into the automation system, parallel to the continuous operation of the automation system and without repercussions thereon. In said automation system, a changeover is effected, without interruption, to a configuration which takes into account the exchanged structural component, such that the modified and exchanged structural component is activated.

By means of the invention, a flexible and multipurpose technical solution is advantageously provided for the smooth modification of automation functions within a control system or automation system.

User-specific and freely configurable structural components can be generated and exchanged at will during continuous operation. An updating of existing components that have already been configured and activated in the automation system can now be carried out without interruptions or effects on the process. In addition, the user has in particular the possibility of initially limiting the updating of the type of structural component to certain instances. Internal consistency checks guarantee a repercussion-free application of configuration modifications.

A further advantage of the invention is based on the fact that it places no additional requirements on the basic automation system and in this way target-system-neutral structural components can be generated. Thus it is possible to run, in one control system, the same structural component for example both in a SIMATIC S7 automation system from Siemens and in a Java-based automation container.

### BRIEF DESCRIPTION OF THE DRAWINGS

The invention is explained in further detail below on the basis of an exemplary embodiment illustrated in the drawings, in which:

FIG. 1 shows a schematic of a first structural component SK1,

FIG. 2 shows a section of a function plan with an instance of the type of structural component defined in FIG. 1,

FIG. 3 shows a schematic of the modified structural component SK1,

FIG. 4 shows a section of a function plan with an instance of the type of structural component defined in FIG. 3 and

FIG. 5 shows a schematic of the subordinate function plan of the modified structural component SK1.

### DETAILED DESCRIPTION OF THE INVENTION

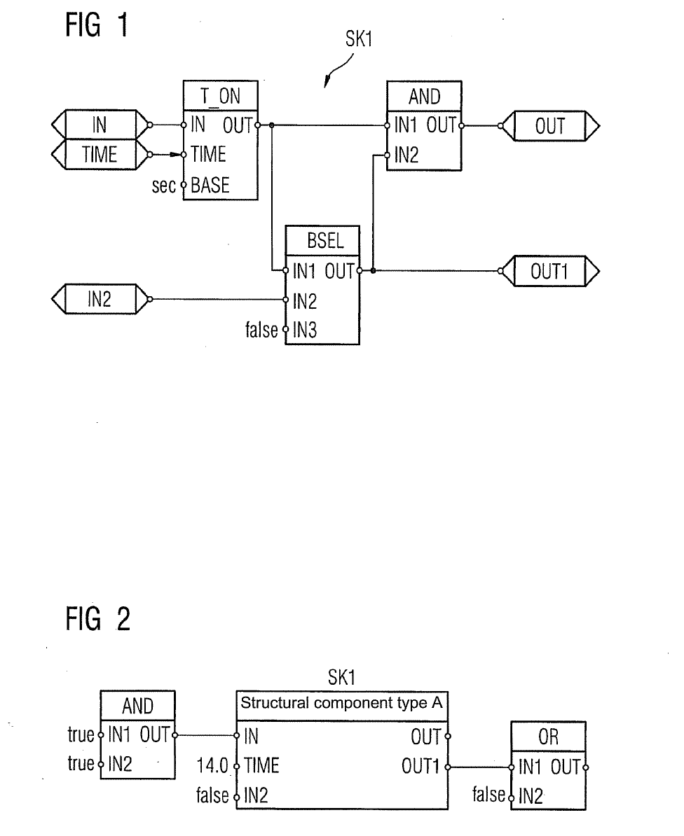

FIG. 1 shows a detailed schematic of a structural component SK1. The structural component SK1 includes in this exemplary embodiment three standard blocks T_ON, BSEL and AND, which are interconnected in order to achieve a certain function. Each block has at least one input and one output. In said exemplary embodiment, the inputs IN and TIME of the block T_ON are connected to the connectors IN and TIME. Accordingly, the input IN2 of the block BSEL is connected to the connector IN2. The connectors arranged on the left-hand side in the figure represent the input interfaces of the structural component SK1. By means of the interfaces, the interaction with other program parts is regulated. The connectors of the output interfaces OUT and OUT1 are arranged on the right-hand side of the figure. They are connected to the corresponding outputs of the blocks AND and BSEL. The structural component SK1 with the described structure is defined here as a structural component of type A. When generating the type of the structural component SK1, an unambiguous identification of the type of structural component is assigned internally (i.e. referring to the existing system). To this end, it is for example possible to assign a GUID (“Globally Unique Identifier”). As a general rule, such a structural component is generated manually by means of a configuration tool (e.g. an editor) in a configuration environment (e.g. a control system). Following generation of the type of structural component SK1 it is for example stored in a program library. Subsequently, the structural component SK1 can be used in the same way as a standard block in the configuration.

FIG. 2 shows the section of a function plan with an instance of the type of structural component SK1 defined previously. Instance refers to the concrete use of the structural component in the function plan. Accordingly, the instantiation of the structural component means the use of the structural component in the function plan and thus in the entire system. The structural component of type A is configured, parameterized and interconnected with other blocks in the function plan. In this exemplary embodiment it is arranged between the logical standard blocks AND and OR. The interconnection with the other blocks can take place via the interfaces IN, TIME, IN2 and OUT and OUT1, only the interfaces IN and OUT1 being interconnected in this example.

In order to protect the know-how which has gone into a structural component, each structural component can be protected by means of a password or a specific license. Should the structural component not be protected in this way, the user can see the detailed interconnection, as it is shown for SK1 for example in FIG. 1. Without the required authorization the user cannot see the underlying interconnection or, depending on the access protection, can open it but not modify it.

In the case of the continuous operation of the automation system, the function plan with all its blocks is activated. An activation of the structural component SK1 means that the function of the structural component in the automation system is executed. Within the function plan, an activation of a structural component can be identified clearly by using color-coding to mark the edges of the blocks that are activated. In the accompanying underlying plan as shown in FIG. 1 for the structural component SK1, the signal flow can also be traced on the basis of color-coding to mark the individual blocks and connectors.

It is subsequently described how an exchange of the structural components SK1 from FIG. 1 during continuous operation of the automation system is carried out independently of the execution of the function of the structural component.

An exchange of structural components can only be carried out for structural components of one type, i.e. only for the same identifiers. This means that when one type of the structural component is modified, the identifier of the structural component, its GUM for example, remains unchanged. Version numbers are, if not explicitly already implemented by the user, automatically increased by the system.

The actual modification of the structural component or, expressed more exactly, of the type of the structural component, is carried out offline in the configuration environment. In the library, in which all types of structural components are stored, the structural component SK1 in this exemplary embodiment is opened, manually modified and stored. Modifications of the type of structural component can take place by adding or removing blocks, interconnections, parameters or external interfaces thereof.

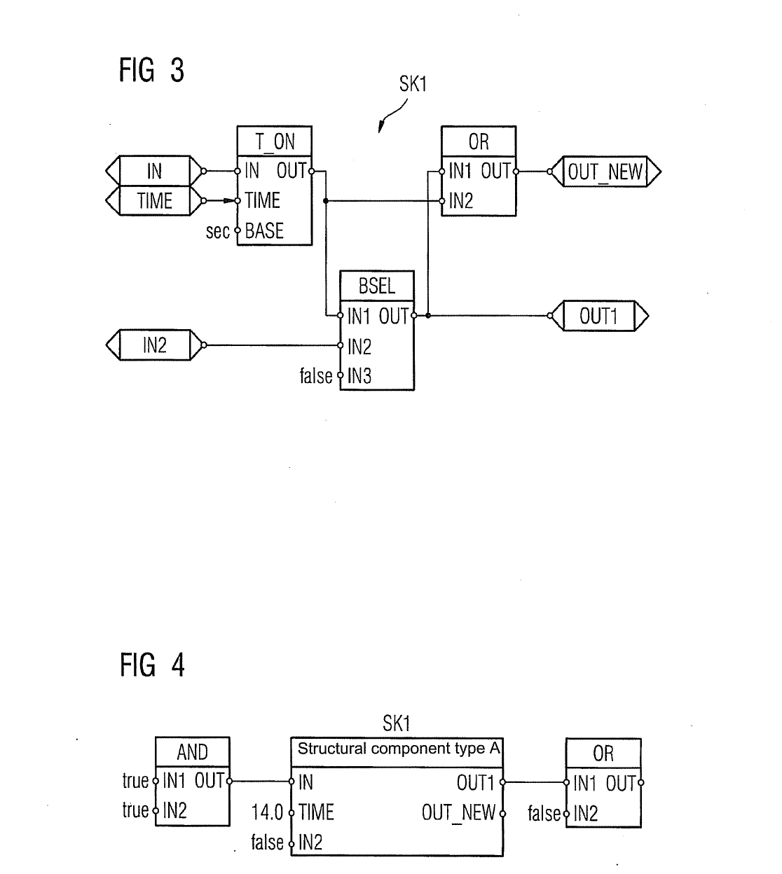

The modified type of structural component of type A of the described exemplary embodiment is shown in the schematic in FIG. 3. The block AND of SK1 with its associated output interface OUT was removed and replaced by a block OR. The interconnections within the structural component were modified accordingly. The same applies to the output interface OUT that was now changed to OUT_NEW.

In a following step, the updating of the modified structural component of the relevant type, identified by the corresponding identifier and already placed in the library, is triggered in the configuration environment. For the updating, it is possible that all instances or only a subset can be selected. This means that the modifications of the structural component SK1 are carried out at all points in the function plan. The execution of the function of the original structural component in the runtime environment of the automation system is not interrupted in this process because the modifications were carried out thus far only in the configuration environment.

A section of the function plan is shown with the modified structural component in FIG. 4. The new output OUT_NEW can be seen at the instance and the originally present output can no longer be seen although the original function plan is still being processed at this point in time in the runtime environment.

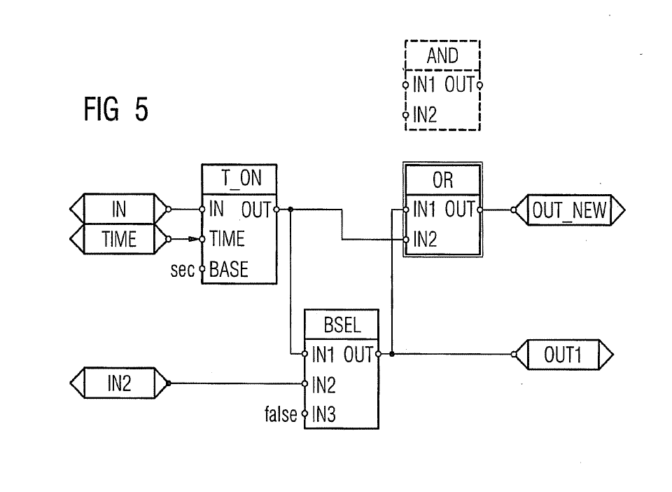

In the associated subordinate plan, as shown in FIG. 5, the modifications made can be traced in detail. The originally present block AND is still visible, but color-contrasted and thus marked graphically. This means that the block in the automation is currently being executed and is still activated. However, by means of the graphic marking, the block in this exemplary embodiment is already designated as being deleted, i.e. it is made known that the block should be deleted in the course of the following activation. Accordingly, the structural modification was recorded in this way. The newly added block OR is graphically shown in such a way that it is apparent that it has not been activated yet. It is for example possible that the edge of the block OR can be marked in a different color than the edge of the activated blocks.

Accordingly, by exchanging the instance of the structural component in the function plan, the modifications made previously to the type of structural component have been traced internally in all configured instances in the configuration environment, as if the user had carried out the modifications manually almost simultaneously for all the relevant instances.

In a final step, the exchanged structural component must be activated, so that the modifications and thus also the updating of the structural component can be carried out in the automation system. This takes place smoothly, i.e. without interruption to continuous operation. To this end, the modifications undertaken are transferred into the automation system, parallel to the continuous operation of the automation system and without repercussions thereon. For this purpose, within the automation system, a modified program is created in a separate configuration area independent of the present program running in the automation system. This program contains the block structure modified by the modified structural component as well as the modified parameters or interconnections. After this parallel configuration has been completely implemented, a changeover is made to the program modified by this configuration, without interruption and fully transparently for the automation system at the next cycle startup. Because after the changeover the previous program configuration is still present in the automation device, it is additionally possible to change over manually or on the basis of an internal operation (e.g. in the case of program overload) to the previous configuration.

After the activation, the function plan shown in FIGS. 3 and 4 appears, the OR block now being activated, which is likewise shown graphically.

The described method can for example also be implemented in the Java programming language. This concerns a software tool at application level.

1.-5. (canceled)

6. A method for exchanging a structural component for an automation system, comprising:
generating a structural component by a configuration tool in a configuration environment;
identifying the structural component unambiguously;
configuring, parameterizing, and interconnecting the structural component with blocks in a function plan;
activating the structural component in a runtime environment based on a function of the structural component executed in the automation system;
modifying the structural component by the configuration tool in the configuration environment during a continuous operation of the automation system independently of the execution of the function of the structural component;
maintaining the identification with the modified structural component;
replacing the structural component in the function plan by the modified structural component as a structural modification;
recording the structural modification correspondingly;
transferring the modified structural component into the automation system parallel to the continuous operation of the automation system without repercussion thereon; and activating the modified structural component for implementing the structural modification so that a changeover of a configuration is effected in the automation system without interruption.

7. The method as claimed in claim 6, wherein the structural component is modified by adding or removing the blocks and modifications of interconnections, parameters, or external interfaces of the blocks.

8. The method as claimed in claim 6, wherein a first configuration and a second configuration are created in the automation system.

9. The method as claimed in claim 8,
wherein the first configuration is always executed in the automation system during the continuous operation,
wherein the modified structural component is transferred to the second configuration while the first configuration is running, and
wherein the modified structural component is activated and the configuration is changed over to the second configuration without interruption.

10. The method as claimed in claim 9, wherein the configuration is changed over to the first configuration without interruption if required.

11. The method as claimed in claim 6, wherein a consistency is checked in the automation system before implementing the structural modification.
